(19) United States
(12) Patent Application Publication
(10) Pub. No.: US 2025/0321959 A1
(43) Pub. Date: Oct. 16, 2025

(54) HYBRID NATURAL LANGUAGE QUERY (NLQ) SYSTEM BASED ON RULE-BASED AND GENERATIVE ARTIFICIAL INTELLIGENCE TRANSLATION

(71) Applicant: ServiceNow, Inc., Santa Clara, CA (US)

(72) Inventors: Sriram Puttagunta, Hyderabad (IN); Nirali Dineshbhai Popat, Hyderabad (IN); Akshay Bhavani Kumar Kulkarni, Hyderabad (IN); Sravan Ramachandran, Bellary (IN); Vipul Mittal, Hyderabad (IN); Ravindra Guntur, Hyderabad (IN); Mangu Venkata Sai Subhadra Lakshmi, Hyderabad (IN); Seganrasan Subramanian, Hyderabad (IN); Ranga Prasad Chenna, Hyderabad (IN)

(21) Appl. No.: 18/632,081

(22) Filed: Apr. 10, 2024

(51) Int. Cl. G06F 16/2452; G06F 16/242; G06F 40/284

(52) U.S. Cl. CPC G06F 16/24522; G06F 16/2425; G06F 40/284

(57) ABSTRACT

A method for querying data in a database system is disclosed. A natural language description is received. A query is generated based on at least a first portion of the natural language description and one or more language processing rules. In response to a determination that the query is not satisfying the one or more language processing rules, at least a second portion of the natural language description is provided to a GenAI model. The query is updated via the GenAI model processing at least the second portion of the natural language description.

### BACKGROUND OF THE INVENTION

Natural language processing (NLP) is an interdisciplinary subfield of computer science and information retrieval. One goal of NLP is to enable computers to understand, interpret, and generate human language in a way that is both meaningful and useful. NLP may include processing natural language datasets, such as text corpora or speech corpora, using either rule-based or probabilistic (e.g., statistical and, most recently, neural network-based) machine learning approaches.

Previously available natural language systems are configured to operate according to predefined grammatical rules. However, many users are not familiar with the predefined grammatical rules. As a result, the natural language systems cannot effectively or efficiently process natural language queries, resulting in the natural language systems generating inaccurate outputs or utilizing a relatively large amount of processing resources. Additionally, maintaining the predefined grammatical rules is intensive and cumbersome for a system administrator.

Existing generative artificial intelligence (generative AI or GenAI) models have a number of disadvantages. For example, GenAI models are subject to hallucination. Further, because GenAI models are typically computationally intense, these systems require graphical processing units (GPUs), which are more costly.

### BRIEF DESCRIPTION OF THE DRAWINGS

Various embodiments of the invention are disclosed in the following detailed description and the accompanying drawings.

FIG. 1 illustrates an example of a block diagram including a Natural Language Query (NLQ) system for querying data in a database system.

FIG. 2A illustrates an example of an NLQ system for querying data in a database system.

FIG. 2B illustrates an example of a process for querying data in a database system.

FIG. 3A illustrates an example of a guardrail module.

FIG. 3B illustrates a table with a plurality of examples in which translated queries are failed by a syntactic guardrail module.

FIG. 3C illustrates a table with a plurality of examples in which translated queries are failed by a semantic guardrail module.

FIG. 4 illustrates an example of an NLQ system for querying data in a database system.

FIG. 5 illustrates an example of a system for data collection and training of an NLQ system for querying data in a database system.

FIG. 6 illustrates a table with a plurality of examples of model output corresponding to different utterances that may be achieved using data augmentation.

FIG. 7 is a functional diagram of a programmed computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A Natural Language Query (NLQ) refers to a type of query or question that a user poses in a natural language, rather than using a specific programming language or query syntax. NLQ allows users to interact with databases, search engines, or other information retrieval systems using everyday language, similar to how they would communicate with another person.

NLQ systems have become increasingly popular due to their ease of use and accessibility, allowing users to interact with complex systems without needing specialized training or knowledge of query languages. They are commonly used in search engines, virtual assistants, business intelligence tools, and other applications where users need to access and analyze data using natural language.

For example, instead of typing a structured query like “SELECT*FROM employees WHERE department=‘Engineering’,” a user could pose a natural language query such as “Show me all the engineers in the company.” The system would interpret this query, understand the user's intent, and retrieve the relevant information from the database.

A configuration management database (CMDB) is a centralized file that functions as a comprehensive data warehouse, organizing information about an information technology (IT) environment. CMDB clarifies the relationships between hardware, software components, and networks for improved configuration management. A CMDB stores information about all the assets and configuration items in an organization's IT environment. These items are organized into tables within the CMDB. While the specific tables can vary depending on the customization and configuration of the CMDB, some tables of CMDB include a core table for storing configuration items (CIs), such as servers, workstations, routers, switches, databases, applications, and other IT assets, a table for storing relationships between the CIs, and the like.

A CMDB query builder may be used to build complex infrastructure and service queries that span multiple CMDB classes, and that involve many CIs that are connected by different relationships.

The GlideRecord API may be used for database operations, including querying, inserting, updating, and deleting records in the CMDB tables. The GlideRecord API may be used for interfacing with the database on the server-side code. A GlideRecord is an object that contains records from a single table. The GlideRecord API may be used to instantiate a GlideRecord object and add query parameters, filters, limits, and ordering.

In various situations, a Natural Language Query (NLQ) system receives, from a user, record-related questions in a natural language. The system translates the questions into database queries, which can be executed at a database.

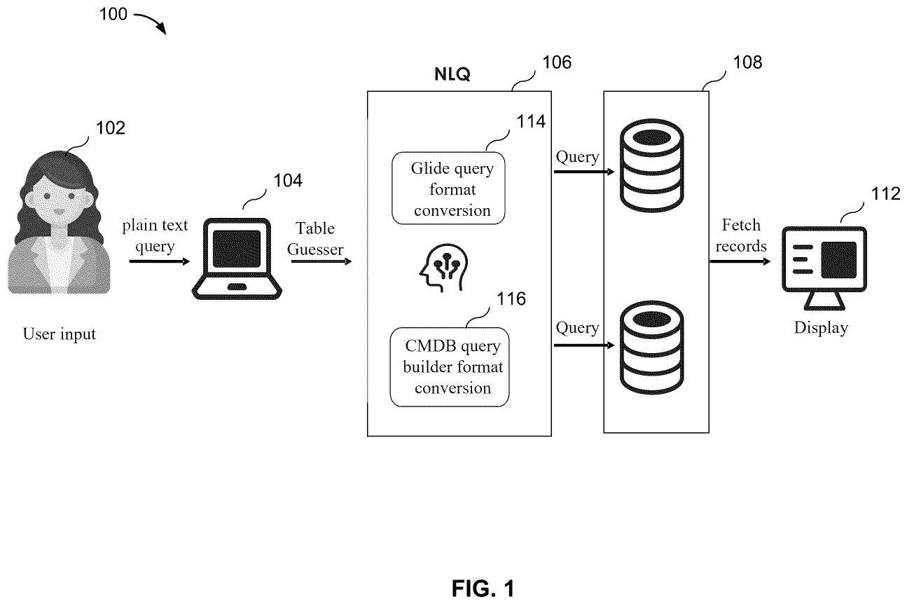

FIG. 1 illustrates an example of a block diagram 100 including a Natural Language Query (NLQ) system 106 for querying data in a database system. For example, NLQ system 106 may be used for querying data in CMDB 108. NLQ system 106 enables a user 102 to query the data in an instance by entering plain text queries (or referred to as utterances) into a user interface 104 and obtain records that are outputted to a display 112. User 102 enters record-related questions directly into user interface 104, and the NLQ system translates them into database queries, which can be executed at a database. The benefit is that with NLQ, the user may query the CMDB through user interface 104 without having to send a formal query.

After receiving a plain text query from user 102, a table guesser module may be used to determine the specific tables that user 102 intends to query about. The table guesser module may record the system's guesses, including their corresponding confidence levels.

NLQ system 106 may include a glide query format conversion module 114 that translates natural language user input into glide record queries. The queries are rendered into an executable structured format, such as a JavaScript Object Notation (JSON) file or a visual definition. NLQ system 106 may include a CMDB query builder format conversion module 116 that translates natural language user input into CMDB queries that may span multiple CMDB classes, and that involves many CIs that are connected by different relationships.

Previously available natural language systems are configured to operate according to predefined grammatical rules. However, many users are not familiar with the predefined grammatical rules. As a result, the natural language systems cannot effectively or efficiently process natural language queries, resulting in the natural language systems generating inaccurate outputs or utilizing a relatively large amount of processing resources. Additionally, maintaining the predefined grammatical rules is intensive and cumbersome for a system administrator.

Existing NLQ systems using generative artificial intelligence (generative AI or GenAI) models have a number of disadvantages. For example, GenAI models are subject to hallucination. Further, because GenAI models are typically computationally intense, these systems require graphical processing units (GPUs), which are more costly.

In the present application, improved techniques for querying data in a database system are disclosed. One aspect of the disclosure includes a method for querying data in a database system. A natural language description is received. A query is generated based on at least a first portion of the natural language description and one or more language processing rules. In response to a determination that the query is not satisfying the one or more language processing rules, at least a second portion of the natural language description is provided to a GenAI model. The query is updated via the GenAI model processing at least the second portion of the natural language description.

Additional implementations of the disclosure may include one or more of the following optional features. The query is executed at a database to retrieve data. One or more database tables are determined based on at least a third portion of the natural language description. The query is generated further based on the determined one or more database tables. The one or more language processing rules are based at least in part on Backus-Naur Form (BNF). In response to a determination that the query satisfies the one or more language processing rules, the query is executed at a database to retrieve data. A result of the large language model is verified based on one or more guardrails, wherein the one or more guardrails comprise syntactic rules. A result of the large language model is verified based on one or more guardrails, wherein the one or more guardrails comprise semantic rules, wherein the semantic rules comprise semantic rules corresponding to one or more of the following: column types, choice values, numbers, dates, or time. Tokens are added to a tokenizer for the large language model, wherein the added tokens include one or more of the following: operators, table names, or column names.

Additional implementations of the disclosure may include one or more of the following optional features. Training data is collected. The large language model is pre-trained or fine-tuned based on the collected training data. Collecting training data comprises collecting training data based on one or more of the following: crowdsourced data, data augmentation, or paraphrasing. The data augmentation comprises data augmentation that generates variations in one or more of the following: dates, years, or numbers. The data augmentation comprises data augmentation that generates variations in one or more of the following: questions or multi-conditions with choice values. The data augmentation comprises data augmentation that generates variations in spelling mistakes.

Another aspect of the disclosure provides a system with one or more processors and a memory coupled to the one or more processors. The memory is configured to provide the one or more processors with instructions. When executed, the instructions cause the one or more processors to receive a natural language description; generate a query based on at least a first portion of the natural language description and one or more language processing rules; in response to a determination that the query is not satisfying the one or more language processing rules, provide at least a second portion of the natural language description to a generative artificial intelligence (GenAI) model; and update the query via the GenAI model processing at least the second portion of the natural language description.

This aspect may include one or more of the following optional features including wherein the memory is further configured to provide the one or more processors with instructions which when executed cause the one or more processors to execute the query at a database to retrieve data, in response to a determination that the query satisfies the one or more language processing rules. The processor is further configured to verify a result of the large language model based on one or more guardrails, wherein the one or more guardrails comprise syntactic rules. The processor is further configured to verify a result of the large language model based on one or more guardrails, wherein the one or more guardrails comprise semantic rules, wherein the semantic rules comprise semantic rules corresponding to one or more of the following: column types, choice values, numbers, dates, or time. The processor is further configured to collect training data, and pre-train or fine-tune the large language model based on the collected training data. Collecting training data comprises collecting training data based on one or more of the following: crowdsourced data, data augmentation, or paraphrasing. The details of one or more implementations of the disclosure are set forth in the accompanying drawings and the description below. Other aspects, features, and advantages will be apparent from the description and drawings, and from the claims.

The current disclosure is aimed at improving NLQ systems. In particular, the improved NLQ system is a hybrid system, combining a rule-based translation module and a GenAI model that complement each other. The GenAI model is invoked only if the rule-based translation module fails. As a result, whenever the rule-based translation module is able to translate the plain text query to a correct database query, the processing by the GenAI model that is more computationally intensive and less time efficient is bypassed. And if the rule-based translation module fails, the GenAI model is used to translate the plain text query to a database query, thereby increasing the total number of queries that are successfully translated. As a result, plain text queries that are written in human natural form are rejected by the NLQ system less often, thereby creating a more positive user experience. The GenAI model used in this framework is not computationally intense and therefore may efficiently run on CPUs.

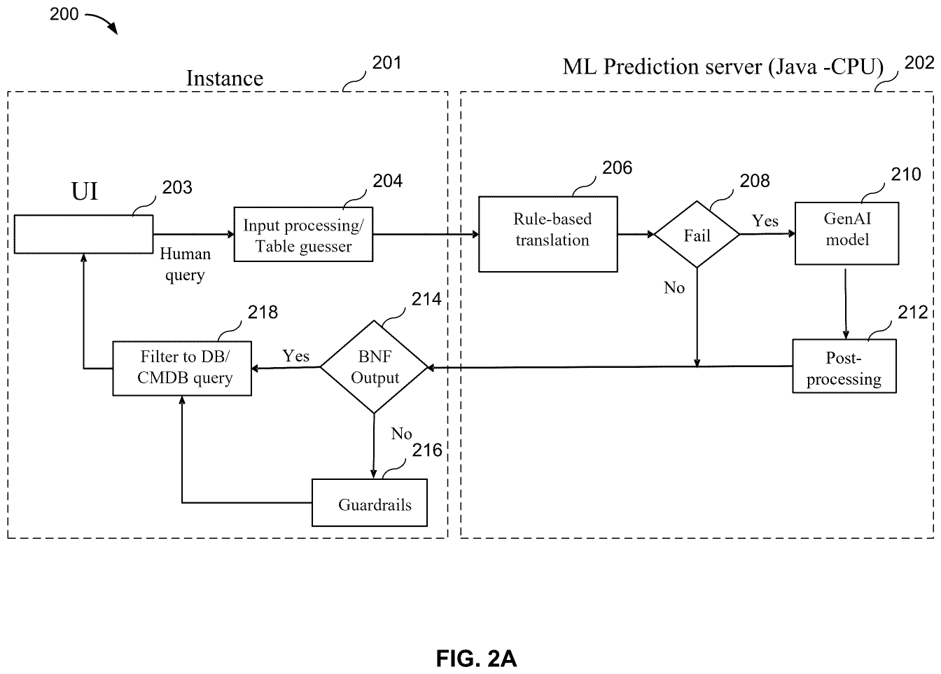

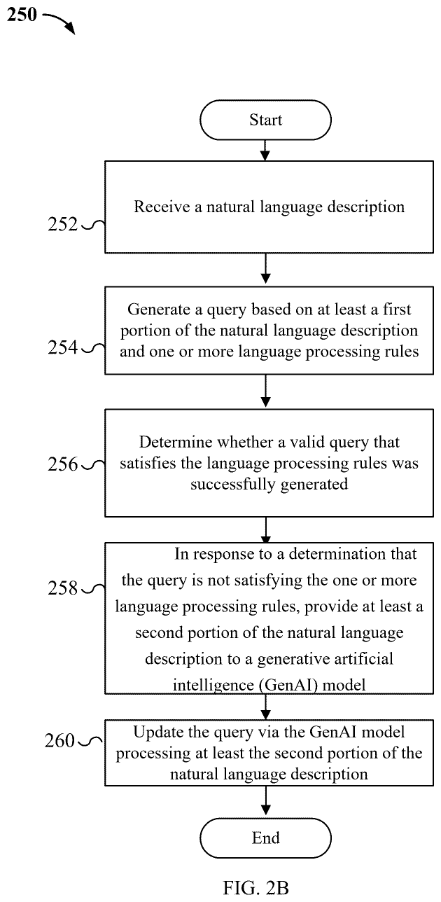

FIG. 2A illustrates an example of an NLQ system 200 for querying data in a database system. NLQ system 200 enables a user to query the data in an instance by entering plain text queries into a user interface (UI) 203 and obtaining records that are outputted to a display. In some embodiments, NLQ system 200 includes a number of steps and modules in an instance 201. In some embodiments, the system includes a number of steps and modules on a machine learning (ML) prediction server 202 that is Java-based and central processing unit (CPU) based.

FIG. 2B illustrates an example of a process 250 for querying data in a database system. In some embodiments, process 250 may be performed by at least a portion of NLQ system 200 in FIG. 2A.

In FIG. 2B, at step 252, a natural language description of desired data is received. The natural language description is also referred to as a plain text query. For example, a human user may provide a natural language description of the desired data as “Please show me all the critical incidents that are not yet assigned.” Another example is “Show me all the engineers in the company.” Another example is “Show me all employees who joined the company after 2019.”

In FIG. 2A, a plain text query entered by a human user is received by user interface 203. The plain text query is received by module 204, which includes an input processing module and a table guesser module. Input processing may include text-related pre-processing. The table guesser module may be used to determine the specific tables within the database that the user intends to query about. The table guesser module may record the system's guesses, including their corresponding confidence levels. The advantage of the table guesser module is that the user does not need to have knowledge of the database structure or how data is internally stored in which tables within the database system. The table guesser module may automatically determine the table(s) that the query is executed at.

In FIG. 2B, at 254, a query is generated based on at least a first portion of the natural language description and one or more language processing rules. For example, using a rule-based engine with one or more language processing rules, at least a portion of the natural language description is processed to attempt to generate a query for the desired data.

In FIG. 2A, the plain text query and the output of the table guesser module are then sent to a rule-based translation module 206, which is a rule-based engine for translating plain text queries into database queries for the selected table(s). In rule-based translation systems, the translation rules are typically written in a structured format that defines how input sentences in one source language are transformed into output sentences in another target language. These rules can be expressed in various forms, such as if-then rules, pattern-action rules, or transformation rules. Rule-based translation is based on information about source and target languages covering the main semantic, morphological, and syntactic regularities of each language respectively.

In some embodiments, rule-based translation module 206 may be based on the Backus-Naur Form (BNF). BNF may be used to describe the syntax of a language or a formal system. BNF is a notation used to describe the syntax of programming languages or other formal languages. Backus-Naur form is applied wherever exact descriptions of languages are needed, such as in official language specifications, in manuals, and in textbooks on programming language theory. BNF can be used to describe document formats, instruction sets, and communication protocols. BNF can inform the design and implementation of translation systems by providing a formal framework for understanding the syntax and structure of languages involved in the translation process.

Rule-based translation module 206 may attempt to generate a query for the desired data. The output of the BNF rule-based translation module 206 includes only two states. The operation is determined as either pass or fail based on the rules. The advantage of the BNF rule-based translation module is that if the module is successful in constructing the output query, then a correct output query is always returned. In addition, the response time of a BNF rule-based translation module is relatively fast. However, the disadvantage of the BNF rule-based translation module is that the input queries must follow a specific grammar that the module can understand, which forces the customers to enter the input queries in a specific pre-defined format. As a result, the failure rate is high (˜50%) and the usage is low. For example, a plain text query entered by a user to the BNF rule-based translation module as “Please show me all the critical incidents that are not yet assigned” may fail, while another text query entered as “All critical incidents unassigned” may pass. Most end users, however, are not familiar with BNF and they may not be aware of the underlying database system. As a result, plain text queries that are written in human natural form are often rejected by the BNF rule-based translation module, thereby creating a negative user experience.

Another problem with using BNF rule-based translation is that maintaining the BNF grammar is labor intensive, cumbersome, and not scalable. For example, a new set of rules and grammar are required to support any new database features. And since a human user may request data from a database system in different ways, it may be difficult for a developer to write rules in the BNF form that can handle all the possible scenarios.

In FIG. 2B, at 256, it is determined whether a valid query that satisfies the language processing rules of the rule-based engine was successfully generated. In FIG. 2A, at 208, the output of the BNF rule-based translation module 206 is then evaluated as either pass or fail. The translation is evaluated as pass if the rule-based engine was successful in generating a valid query, and it is evaluated as fail if the rule-based engine was not successful in generating a valid query. If the output indicates that the translation passes, then the translated output query generated by BNF rule-based translation module 206 is sent to 214. At 214, it is determined that the translated output is the output of the BNF rule-based translation module 206. At 218, the output of the BNF rule-based translation module 206 is the translated database query that is executed at the database or CMDB, retrieving the relevant data. The retrieved data is then sent to UI 203.

In FIG. 2B, at 258, in response to a determination that the query is not satisfying the one or more language processing rules of the rule-based engine, at least a second portion of the natural language description is provided to a GenAI model. In FIG. 2A, if the output at 208 indicates that the translation by the rule-based engine fails, then at least a portion of the output of BNF rule-based translation module 206 is sent to a large language model, such as a generative artificial intelligence (generative AI or GenAI) model 210. In some embodiments, the output of BNF rule-based translation module 206 that is sent to GenAI model 210 includes the natural language description entered by the human user and received by user interface 203.

GenAI is artificial intelligence capable of generating text, images, or other data using generative models in response to prompts. Generative AI models learn the patterns and structure of their input training data and then generate new data that has similar characteristics. GenAI model 210 receives the plain text query as input.

In one example, the plain text query is in natural language, such as “Show me all employees who joined the company after 2019.” GenAI model 210 may parse and understand the query using natural language processing (NLP) techniques. This involves identifying the entities, relationships, conditions, and actions described in the query. For example, in the query mentioned above, entities might include “employees,” “company,” and “joining date,” while conditions might include “joining date after 2019.” Based on the parsed information, GenAI model 210 generates a corresponding database query. This could involve translating the natural language query into a database query that is suitable for the database being queried. For example, GenAI model 210 may generate a database query “SELECT*FROM employees WHERE joining_date >‘2019-01-01’” as the output.

In comparison to BNF rule-based translation module 206, GenAI model 210 has certain disadvantages. Unlike a rule-based model, GenAI model 210 output is not guaranteed to be always correct. GenAI model 210, like other generative AI models, is subject to hallucination. Generative AI hallucination refers to a phenomenon where a generative model produces outputs that exhibit unexpected or surreal characteristics, diverging significantly from the data it was trained on. The complexity of GenAI model 210 is higher than a rule-based model and therefore the generation of results by GenAI model 210 is relatively slower. Typically, since GenAI models are computationally intense, they require graphical processing units (GPUs), which incur additional cost.

NLQ system 200 has the advantage of being a hybrid system, combining a rule-based translation module and a GenAI model that complement each other. Note that GenAI model 210 is invoked only if BNF rule-based translation module 206 fails. As a result, whenever BNF rule-based translation module 206 is able to translate the plain text query to a correct database query, the processing by GenAI model 210 that is more computationally intensive and less time efficient is bypassed. And if the rule-based translation module fails, GenAI model 210 is used to translate the plain text query to a database query, thereby increasing the total number of queries that are successfully translated. As a result, plain text queries that are written in human natural form are rejected by NLQ system 200 less often, thereby creating a more positive user experience.

In FIG. 2B, at 260, the query is updated via the GenAI model processing at least the second portion of the natural language description. GenAI model 210 generates a database query based on the natural language description. For example, a database filter query in a JavaScript Object Notation (JSON) format may be generated, which may be further converted to an SQL query to be executed at the database. In some embodiments, the result of the GenAI model is processed by a post-processing module and a guardrail module before a database query for obtaining the desired data is provided. In FIG. 2A, the output query generated by GenAI model 210 is then received by a post-processing module 212. The post-processing module 212 may modify the output query generated by GenAI model 210 to ensure that the output query is in a specific format. In one example, the output query generated by GenAI model 210 is missing a double quote, and post-processing module 212 is used to modify the output query to include the missing double quote. In one example, a portion of the output query generated by GenAI model 210 (e.g., the phrase “true”) should be capitalized, and post-processing module 212 is used to modify the output query to replace the small letter “t” in the phrase “true” to a capital “T” to make it a Boolean type “True.” In one example, the output query generated by GenAI model 210 includes extra spaces, and post-processing module 212 is used to modify the output query to remove the extra spaces.

The output generated by post-processing module 212 is sent to 214. At 214, it is determined that the translated output is not the output of the BNF rule-based translation module 206, and the translated output query is sent to a guardrail module 216.

Guardrail module 216 is used to mitigate GenAI hallucinations by GenAI model 210. These guardrails act as constraints or rules that guide the Al's output generation process, ensuring the content remains within acceptable boundaries. By defining limits on the generated content, such as adhering to known facts, the likelihood of hallucinations is reduced and more accurate and reliable results are produced. For example, guardrail module 216 may include syntactic and semantic constraints or rules that reduce hallucinations significantly. In some embodiments, guardrail module 216 only determines whether the output query passes or fails the guardrails. In some embodiments, guardrail module 216 corrects the output query based on the guardrails.

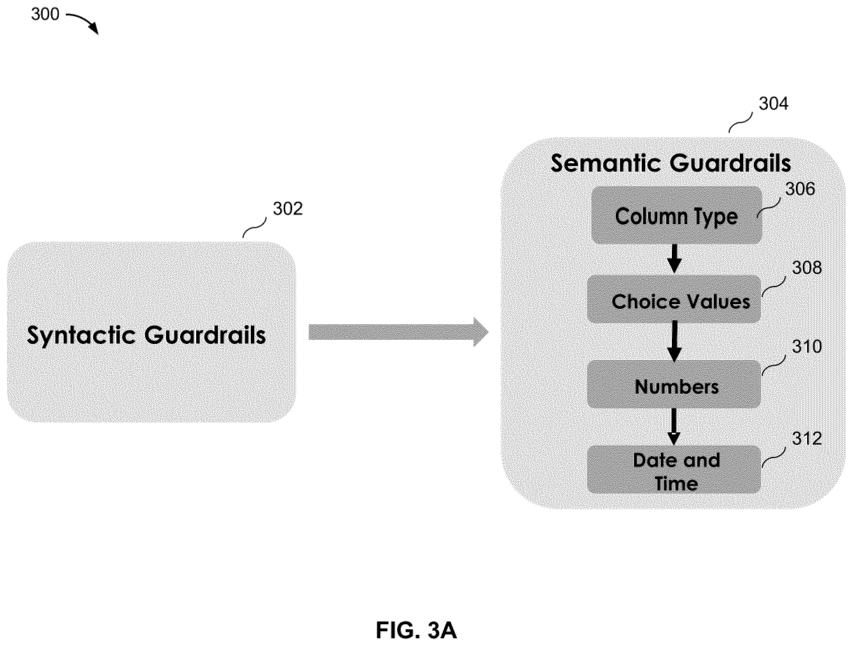

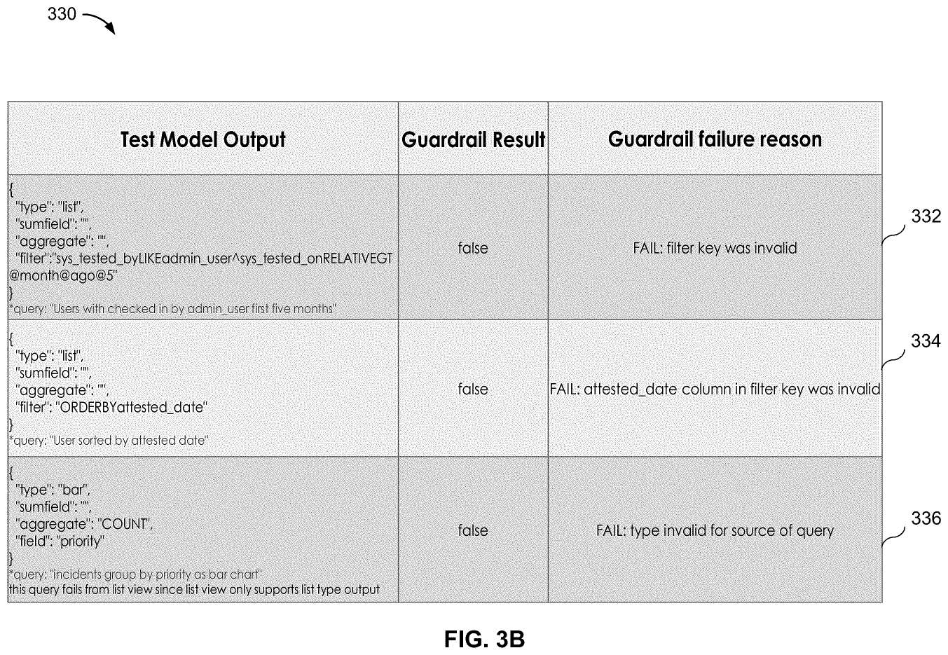

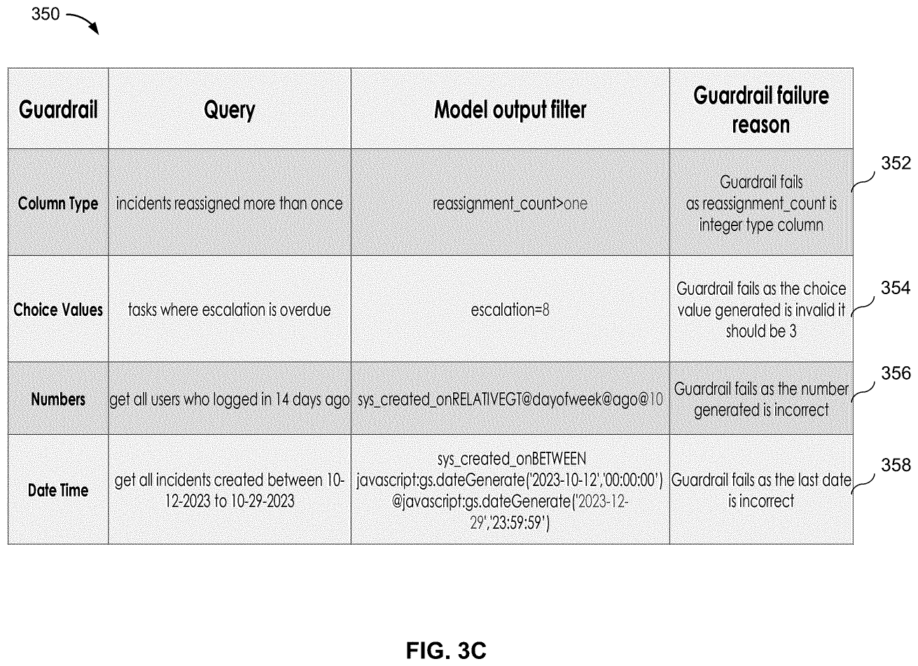

FIG. 3A illustrates an example of a guardrail module 300. In some embodiments, guardrail module 300 may be at least a portion of guardrail module 216 in FIG. 2A. Guardrail module 300 includes a syntactic guardrail module 302 and a semantic guardrail module 304. In semantic guardrail module 304, the column type (306), choice values (308), numbers (310), and date and time (312) are verified based on semantic constraints or rules.

FIG. 3B illustrates a table 330 with a plurality of examples in which translated queries are failed by syntactic guardrail module 302. The translated queries in the leftmost column are database filter queries in the JSON format. In row 332, the output query failed because the filter key was invalid. In row 334, the output query failed because the attested_date column in the filter key was invalid. In row 336, the output query failed because the type is invalid for the source of the query.

FIG. 3C illustrates a table 350 with a plurality of examples in which translated queries are failed by semantic guardrail module 304. In row 352, the plain text query is “incidents reassigned more than once” and the output query is “reassignment_count>one.” The guardrail for verifying the column type fails because the reassignment_count should have an integer type column. Therefore, guardrail module 216 modifies the output query to “reassignment_count>1.”

In row 354, the plain text query is “tasks where escalation is overdue” and the output query is “escalation=8” The guardrail for verifying the choice values fails because the choice value generated is invalid and should be 3.

In row 356, the plain text query is “get all users who logged in 14 days ago” and the output query is “sys_created_onRELATIVEGT@dayofweek@ago@10.” The guardrail for verifying the numbers fails because the number generated is incorrect. The output query is syntactically valid, but semantically incorrect.

In row 358, the plain text query is “get all incidents created between Oct. 12, 2023 to Oct. 29, 2023” and the output query is “sys_created_onBETWEENjavascript:gs.dateGenerate(‘2023-10-12’, ‘00:00:00’)@javascript:gs.dateGenerate(‘2023-12-29’,‘23:59:59’).” The guardrail for verifying the date and time fails because one of the dates is incorrect.

Referring back to FIG. 2A, at 218, the output of guardrail module 216 is the translated database query that is executed at the database or CMDB, retrieving the relevant data. The retrieved data is then sent to UI 203.

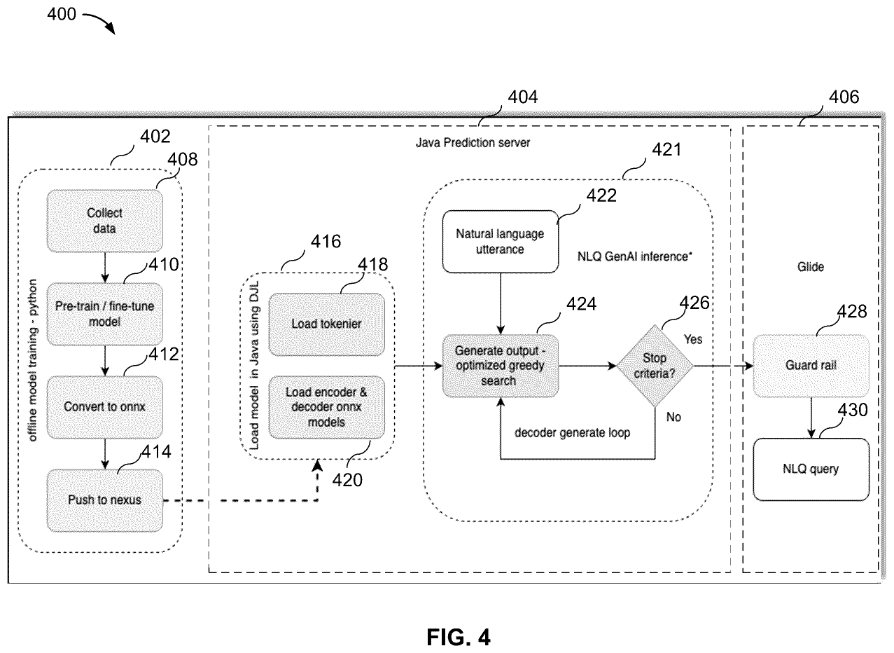

FIG. 4 illustrates an example of an NLQ system 400 for querying data in a database system. NLQ system 400 translates a natural language utterance 422 into an NLQ query 430. In some embodiments, NLQ system 400 may be at least a portion of NLQ system 106 in FIG. 1 or at least a portion of NLQ system 200 in FIG. 2. In some embodiments, NLQ system 400 includes a number of steps and modules in an offline model training module 402. In some embodiments, offline model training module 402 may be implemented in the Python programming language. In some embodiments, NLQ system 400 includes a number of steps and modules on a prediction server 404 that is Java-based and central processing unit (CPU) based. In some embodiments, NLQ system 400 includes a glide query module 406 that includes a guardrail module 428.

At 408, training data is collected. At 410, the collected training data is used for pre-training or fine-tuning the ML model. Pre-training involves training a model on a large dataset, typically a general dataset that may or may not be directly related to the task the model is expected to perform. Pre-training initializes the model's parameters with weights learned from this large dataset, which helps the model capture general patterns and features present in the data. Fine-tuning involves taking a pre-trained model and further training it on a smaller, task-specific dataset. The pre-trained model serves as a starting point, and the fine-tuning process adjusts the model's parameters to better fit the new dataset and the specific task at hand. Fine-tuning allows leveraging the knowledge captured by the pre-trained model while adapting it to the nuances of the target task or dataset. Fine-tuning is especially useful when you have a limited amount of data for your specific task, as it allows you to transfer knowledge from the pre-trained model to improve performance on the new task.

At 412, the trained model is converted to the Open Neural Network Exchange (ONNX) format. For example, the ML model implemented in the Python programming language may be converted to the ONNX format. ONNX is an open-source artificial intelligence ecosystem of technology companies and research organizations that establish open standards for representing machine learning algorithms and software tools to promote innovation and collaboration in the AI sector. The ONNX format serves as a standardized format for representing and exchanging deep learning models, promoting interoperability and portability across different frameworks and runtime environments.

At 414, the ML model in the ONNX format is sent to Nexus. Nexus is a repository manager used for managing binary components and artifacts in software development projects. Nexus can be used to store and manage ONNX models. As prediction server 404 that includes GenAI model 421 is Java-based, it may interact with Nexus repositories to retrieve ONNX models and other dependencies needed for machine learning applications.

At 416, the ML model is loaded into the Java environment using DJL. DJL stands for Deep Java Library. It is an open-source deep learning framework developed primarily for Java developers. DJL aims to simplify the process of building, training, and deploying deep learning models within Java applications.

At 418, the tokenizer is loaded. At 420, encoder and decoder ONNX models are loaded. A tokenizer is a preprocessing component used to break down raw text data into smaller units called tokens. These tokens are the atomic units of text that are used as input to natural language processing (NLP) models. In some embodiments, a customized tokenizer may be used to improve the model performance by adding custom tokens, including operators, table names, column names, and the like.

A database query for a particular type of database may include unique operators and table names. Custom tokens help the model to learn the relationships for improved performance of the model. For example, a plain text query of “records with SLA due is no more than one hour” may be translated to the database query of “sla_dueRELATIVEGT@hour@ago@1.” A default SentencePiece tokenizer does not recognize the operators “sla_due” or “RELATIVEGT.” As a result, “sla_due” may be broken down into four tokens “sla_du e” and “RELATIVEGT” may be broken down into five tokens “RE LA T IVE GT.” By adding custom tokens, such as “sla_due” and “RELATIVEGT,” the number of output tokens generated by the customized tokenizer are reduced.

The Java-based GenAI model 421 is used for NLQ GenAI inference. GenAI model 421 translates a natural language utterance 422 into an NLQ query 430. At 424, optimized greedy search is performed. At 426, it is determined whether the stop criteria are met. If the stop criteria are not met, then another iteration of the decoder generate loop is performed. Otherwise, the generated output is sent to guardrail module 428, which may be used to correct the output query based on the guardrails.

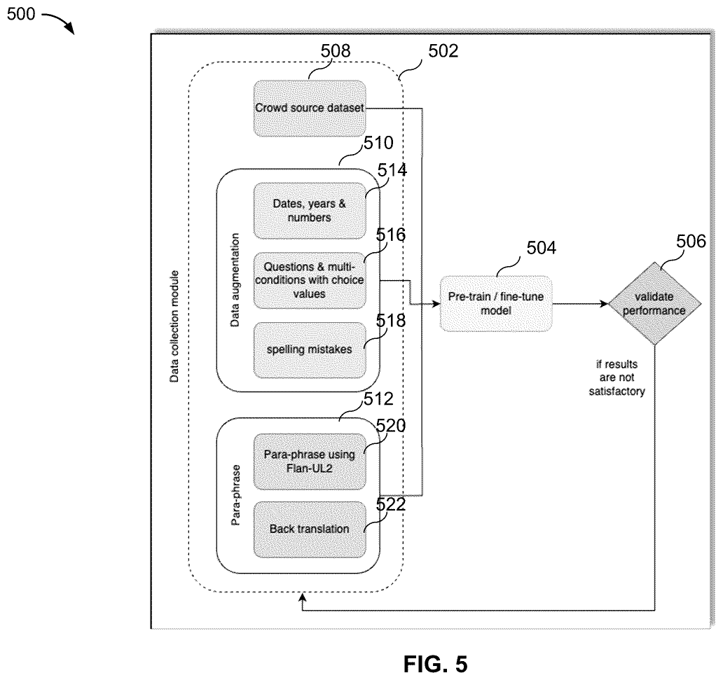

FIG. 5 illustrates an exemplary system 500 for data collection and training of an NLQ system for querying data in a database system. In some embodiments, system 500 may be at least a portion of offline model training module 402 in FIG. 4. In some embodiments, system 500 includes a number of steps and modules in a data collection module 502, which includes a data augmentation module 510 and a paraphrase module 512. At 504, the collected training data is used for pre-training or fine-tuning the ML model. At 506, the performance of the model is validated. If the results are not satisfactory, then training of the ML model is repeated.

Crowdsourced data, data augmentation, and paraphrasing may be used to enhance the quality and quantity of the training data for the ML model. The advantage is that the model can generalize well on a wide variety of database queries based on a small initial set of training examples. Crowdsource datasets 508 are used for fine-tuning of the ML model. Crowdsourcing refers to the practice of obtaining labeled data or annotations for training machine learning models from a large group of people, often referred to as a “crowd.” Data augmentation module 510 performs data augmentation, which involves artificially increasing the size or diversity of a dataset by applying a variety of transformations or modifications to the existing data. Data augmentation involves generating synthetic variations of existing data through automated transformations. Paraphrase module 512 performs paraphrasing, which involves generating a sentence or text that conveys the same meaning as another sentence or text, but with different wording or phrasing.

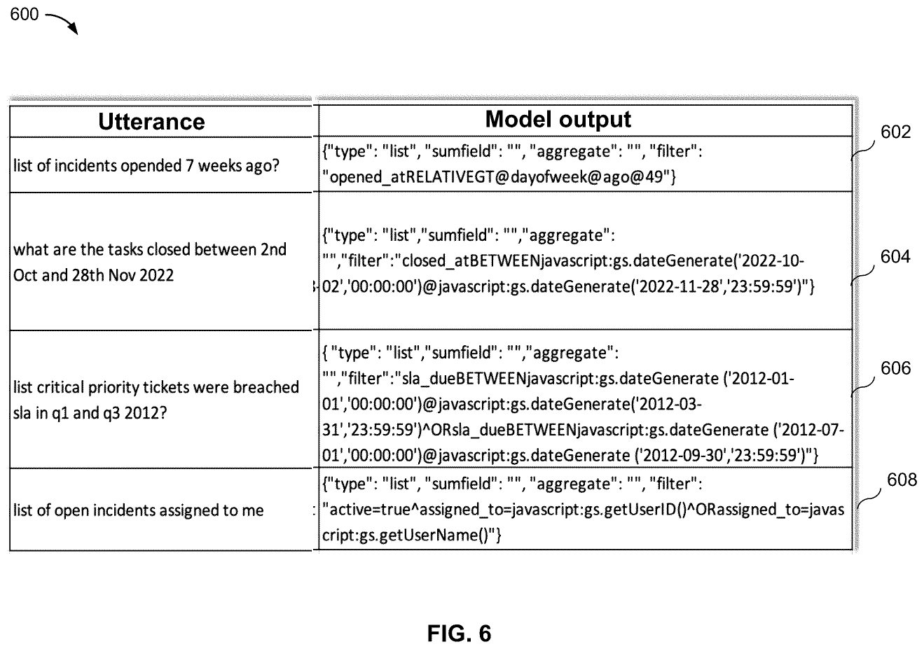

A data augmentation sub-module 514 may be used for improving the model in handling dates, years, or numbers. A data augmentation sub-module 516 may be used for improving the model in handling questions and multi-conditions with choice values. A data augmentation sub-module 518 may be used for improving the model in handling spelling mistakes. FIG. 6 illustrates a table 600 with a plurality of examples (602, 604, 606, and 608) of model output corresponding to different utterances that may be achieved using data augmentation.

In row 606, the utterance is “list critical priority tickets were breached sla in q1 and q3 2012?” A fiscal quarter refers to one-fourth of a year and is typically expressed as Q1 for the first quarter, Q2 for the second quarter, and so forth. Since a user text query may specify a time period based on quarters, the model needs to understand that q1 means the first three months (January to March) of the year and that q3 means the months from July to September of the year. Accordingly, data augmentation sub-module 514 may generate training data that teaches the model that q1 means the first three months (January to March) of the year and that q3 means the months from July to September of the year.

In row 602, the utterance is “list of incidents opened 7 weeks ago?” Data augmentation sub-module 514 may generate training data that teaches the model to convert 7 weeks into 49 days. Furthermore, data augmentation sub-module 518 may generate training data that teaches the model to recognize that “opended” is a misspelling of the word “opened.”

Referring back to FIG. 5, paraphrase module 512 performs paraphrasing, which involves generating a sentence or text that conveys the same meaning as another sentence or text, but with different wording or phrasing. Paraphrase module 512 may include a paraphrase module 520 based on Flan-UL2. Flan-UL2 is an open source LLM model used for paraphrasing.

Paraphrase module 512 may include a back translation module 522. Back translation is a technique for improving the robustness and accuracy of machine translation models, particularly when training data in the target language is limited or scarce. The basic idea behind back translation is to generate synthetic training data by translating text from the target language back into the source language. By generating synthetic examples through back translation, the model can learn to handle a wider range of linguistic variations and improve its translation quality.

As disclosed above, NLQ system 200 has the advantage of being a hybrid system, combining a rule-based translation module and a GenAI model that complement each other. NLQ system 200 allows the customers to submit the queries in a more natural language format. In addition, NLQ system 200 includes various improved techniques that are performed in various modules of the system, including the modules for the table guesser, guardrails, pre-training and fine-tuning, and customized tokenizer. Another advantage of such an improved system is that the large language model (LLM) is powerful but small (e.g., a FLAN-T5 LLM that is 300-400 MB in ONNX). The GenAI model used in this framework is not computationally intense and therefore may efficiently run on CPUs. As a result, existing infrastructure for inference may be used without requiring GPUs or other additional resources, thereby significantly reducing the cost of the system.

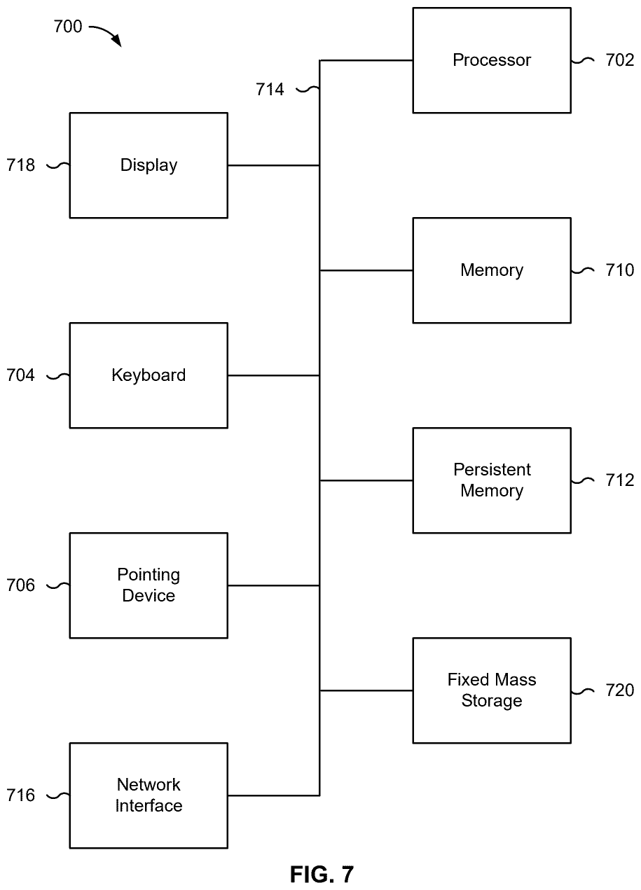

FIG. 7 is a functional diagram of a programmed computer system. In some embodiments, at least parts of system 106 in FIG. 1, system 200 in FIG. 2A, process 250 in FIG. 2B, module 300 in FIG. 3A, system 400 in FIG. 4, and system 500 in FIG. 5 are executed by computer system 700. Computer system 700 is an example of a processor.

In the example shown, computer system 700 includes various subsystems as described below. Computer system 700 includes at least one microprocessor subsystem (also referred to as a processor or a central processing unit (CPU)) 702. Computer system 700 can be physical or virtual (e.g., a virtual machine). For example, processor 702 can be implemented by a single-chip processor or by multiple processors. In some embodiments, processor 702 is a general-purpose digital processor that controls the operation of computer system 700. Using instructions retrieved from memory 710, processor 702 controls the reception and manipulation of input data, and the output and display of data on output devices (e.g., display 718).

Processor 702 is coupled bi-directionally with memory 710, which can include a first primary storage, typically a random-access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also, as is well known in the art, primary storage typically includes basic operating instructions, program code, data, and objects used by the processor 702 to perform its functions (e.g., programmed instructions). For example, memory 710 can include any suitable computer-readable storage media, described below, depending on whether, for example, data access needs to be bi-directional or uni-directional. For example, processor 702 can also directly and very rapidly retrieve and store frequently needed data in a cache memory (not shown).

Persistent memory 712 (e.g., a removable mass storage device) provides additional data storage capacity for computer system 700, and is coupled either bi-directionally (read/write) or uni-directionally (read only) to processor 702. For example, persistent memory 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of fixed mass storage 720 is a hard disk drive. Persistent memory 712 and fixed mass storage 720 generally store additional programming instructions, data, and the like that typically are not in active use by the processor 702. It will be appreciated that the information retained within persistent memory 712 and fixed mass storages 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, pointing device 706 can be a mouse, stylus, track ball, or tablet, and is useful for interacting with a graphical user interface.

Network interface 716 allows processor 702 to be coupled to another computer, computer network, or telecommunications network using a network connection as shown. For example, through network interface 716, processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect computer system 700 to an external network and transfer data according to standard protocols. Processes can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
receiving a natural language description;
generating a query based on at least a first portion of the natural language description and one or more language processing rules;
in response to a determination that the query does not satisfy the one or more language processing rules, providing at least a second portion of the natural language description to a generative artificial intelligence (GenAI) model; and
updating the query via the GenAI model processing at least the second portion of the natural language description.

2. The method of claim 1, further comprising:
executing the query at a database to retrieve data.

3. The method of claim 1, further comprising:
determining one or more database tables based on at least a third portion of the natural language description; and
generating the query further based on the determined one or more database tables.

4. The method of claim 1, wherein the one or more language processing rules are based at least in part on Backus-Naur Form (BNF).

5. The method of claim 1, further comprising:
in response to a determination that the query satisfying the one or more language processing rules, executing the query at a database to retrieve data.

6. The method of claim 1, further comprising:
verifying a result of the large language model based on one or more guardrails, wherein the one or more guardrails comprise syntactic rules.

7. The method of claim 1, further comprising:
verifying a result of the large language model based on one or more guardrails, wherein the one or more guardrails comprise semantic rules, wherein the semantic rules comprise semantic rules corresponding to one or more of the following: column types, choice values, numbers, dates, or time.

8. The method of claim 1, further comprising:
collecting training data; and
pre-training or fine-tuning the large language model based on the collected training data.

9. The method of claim 8, wherein collecting the training data comprises collecting training data based on one or more of the following: crowdsourced data, data augmentation, or paraphrasing.

10. The method of claim 9, wherein the data augmentation comprises data augmentation that generates variations in one or more of the following: dates, years, or numbers.

11. The method of claim 9, wherein the data augmentation comprises data augmentation that generates variations in one or more of the following: questions or multi-conditions with choice values.

12. The method of claim 9, wherein the data augmentation comprises data augmentation that generates variations in spelling mistakes.

13. The method of claim 1, further comprising:
adding tokens to a tokenizer for the large language model, wherein the added tokens include one or more of the following: operators, table names, or column names.

14. A system comprising:
a processor configured to:
receive a natural language description;
generate a query based on at least a first portion of the natural language description and one or more language processing rules;
in response to a determination that the query does not satisfy the one or more language processing rules, provide at least a second portion of the natural language description to a generative artificial intelligence (GenAI) model; and
update the query via the GenAI model processing at least the second portion of the natural language description; and
a memory coupled to the processor and configured to provide the processor with instructions.

15. The system of claim 14, wherein the processor is further configured to:
in response to a determination that the query satisfies the one or more language processing rules, execute the query at a database to retrieve data.

16. The system of claim 14, wherein the processor is further configured to:
verify a result of the large language model based on one or more guardrails, wherein the one or more guardrails comprise syntactic rules.

17. The system of claim 14, wherein the processor is further configured to:
verify a result of the large language model based on one or more guardrails, wherein the one or more guardrails comprise semantic rules, wherein the semantic rules comprise semantic rules corresponding to one or more of the following: column types, choice values, numbers, dates, or time.

18. The system of claim 14, wherein the processor is further configured to:
collect training data; and
pre-train or fine-tune the large language model based on the collected training data.

19. The system of claim 18, wherein collecting the training data comprises collecting training data based on one or more of the following: crowdsourced data, data augmentation, or paraphrasing.

20. A computer program product embodied in a non-transitory computer readable medium and comprising computer instructions for:
receiving a natural language description;
generating a query based on at least a first portion of the natural language description and one or more language processing rules;
in response to a determination that the query does not satisfy the one or more language processing rules, providing at least a second portion of the natural language description to a generative artificial intelligence (GenAI) model; and
updating the query via the GenAI model processing at least the second portion of the natural language description.
